(19) United States
(12) Patent Application Publication
(10) Pub. No.: US 2026/0331023 A1
(43) Pub. Date: Oct. 22, 2026

(54) DISPLAY DRIVE DEVICE AND DISPLAY DEVICE COMPRISING SAME

(71) Applicant: LX SEMICON CO.,LTD., Daejeon (KR)

(72) Inventor: Young Bok KIM, Daejeon (KR)

(73) Assignee: LX SEMICON CO., LTD., Daejeon (KR)

(21) Appl. No.: 18/994,220

(22) PCT Filed: Jul. 20, 2023
(86) PCT No.: PCT/KR2023/010480

§ 371 Date: Jan. 14, 2025

(30) Foreign Application Priority Data
Jul. 28, 2022 (KR) 10-2022-0093921

(51) Int. Cl. G09G 3/20; G09G 3/3275

(52) U.S. Cl. CPC G09G 3/2096; G09G 3/3275; G09G 2310/0286; G09G 2310/0289

(57) ABSTRACT

Disclosed is a display drive device or display device according to various embodiments. Disclosed are a method and a device therefor, the device comprising: first and second buffers electrically connected to first and second panel link wires, respectively, of a display panel; a first bias current transistor for supplying a first bias current to the first buffer and a second bias current transistor for supplying a second bias current to the second buffer; and a first current control unit for supplying a gate current to each of the first and second bias current transistors, wherein the sizes of the first bias current and the second bias current are determined on the basis of the lengths of the first panel link wire and the second panel link wire, respectively.

### TECHNICAL FIELD

The present specification relates to a display drive device and a display device comprising the same.

### BACKGROUND ART

Representative examples of display devices that show images include liquid crystal displays (LCD), which use liquid crystals, organic light-emitting diode (OLED) displays, which use organic light-emitting diodes, and the like.

The display devices described above include a panel for displaying an image through a pixel array, a panel driver for driving the panel, and a timing controller for controlling the panel driver, wherein the panel driver includes a gate driver for driving gate lines of the panel, and a data driver for driving data lines of the panel.

When image data is received from an external system, the typical timing controller provides the received image data to the data driver along with predetermined control information. The data driver samples and latches the image data in digital format according to a predetermined control signal received from the timing controller, converts the digital image data into an analog type of source signal, and outputs the analog type of source signal to the display panel.

Such a source signal is output to the display panel through data lines of the display panel and link wires connecting the data lines and the data driver. In this case, as the size of the display panel increases, the difference between the length of a link line connected to a data line in the edge portion of the display panel and the length of a link line connected to a data line in the central portion of the display panel increases, and correspondingly, the difference between the resistance of the link line connected to the data line in the edge portion of the display panel and the resistance of the link line connected to the data line in the center portion of the display panel may increase.

### DISCLOSURE

### Technical Problem

The present disclosure is intended to solve the above-mentioned problem, and its technical task is to provide a display drive device and a drive device for compensating for resistance differences in the link wires connecting the data line and the data driver.

Technical tasks are not limited to those mentioned above, and other technical tasks not mentioned will become apparent to those having ordinary skill in the art from the following description.

### Technical Solution

A display drive device according to one aspect includes: first and second buffers that are electrically connected to first and second panel link wires of a display panel, respectively; a first bias current transistor configured to supply a first bias current to the first buffer, and a second bias current transistor configured to supply a second bias current to the second buffer; and a first current controller configured to supply a gate current to each of the first and second bias current transistors, wherein the magnitude of the first bias current and the second bias current is determined based on a length of each of the first panel link wire and the second panel link wire.

Additionally, when the first panel link wire has a shorter length than the second panel link wire, the first bias current has a smaller value than the second bias current.

Additionally, when the first panel link wire has a shorter length than the second panel link wire, a gate current input to the first bias current transistor has a smaller value than a gate current input to the second bias current transistor.

Additionally, the first bias transistor is: connected to the current controller via its gate electrode to receive the gate current input as an input, connected to a ground voltage GND via its source electrode, and connected to the first buffer via its drain electrode.

Additionally, the source-drain current of the first bias current transistor is input to the first buffer as the first bias current.

Additionally, the display drive device further includes at least one bias resistor located between the first bias current transistor and the second bias current transistor.

Additionally, the display drive device further includes: third and fourth buffers electrically connected to third and fourth panel link wires of the display panel, respectively; third and fourth bias current transistors configured to supply bias currents to the third and fourth buffers, respectively; and a second current controller configured to supply a gate current to each of the third and fourth bias current transistors, wherein the third and fourth bias current transistors supply the bias currents to the third and fourth buffers connected to the third and fourth panel link wires in proportion to the lengths of the third and fourth panel link wires, respectively.

A display device according to another aspect includes: first and second data lines connected to pixels and configured to supply source signals; a data drive device configured to output the source signals to the first and second data lines; and first and second panel link wires configured to electrically connect the first and second data lines and the data drive device, wherein the data drive device includes: first and second buffers that are electrically connected to the first and second panel link wires, respectively; a first bias current transistor configured to supply a first bias current to the first buffer, and a second bias current transistor configured to supply a second bias current to the second buffer; and a first current controller configured to supply a gate current to each of the first and second bias current transistors, and wherein the magnitude of the first bias current and the second bias current is determined based on each length of the first panel link wire and the second panel link wire.

### ADVANTAGEOUS EFFECTS

Various embodiments may compensate for slew rate differences caused by differences in the lengths of the link wires connecting the data lines and the data drive without changing the structure of the link wires in the display panel.

Alternatively, the bias currents, which are proportional to the lengths of the panel link wires connected to the plurality of bias current transistors, may be supplied to the buffers connected to the plurality of bias current transistors by means of the plurality of bias resistors respectively disposed among the plurality of bias current transistors and the current controller for supplying the gate current to the plurality of bias current transistors, whereby the slew rate of the source signals output from the respective buffers may be compensated.

The effects that may be obtained in various embodiments are not limited to the effects mentioned above, and other effects not mentioned may be clearly understood by those skilled in the art to which the present disclosure pertains from the following description.

### BRIEF DESCRIPTION OF THE DRAWINGS

The drawings attached herein are intended to provide an understanding of the present disclosure, and are intended to show various embodiments of the present disclosure and to explain the principles of the present disclosure together with the description in the specification.

FIG. 1 is a diagram illustrating the configuration of a display device according to one embodiment of the present disclosure;

FIG. 2 is a plan view of a part A in FIG. 1;

FIG. 3 is a block diagram schematically illustrating the configuration of a data driver according to one embodiment of the present disclosure;

FIG. 4 is a circuit diagram illustrating an output buffer part and a bias current generating part according to one embodiment of the present disclosure;

FIG. 5 is a graph of a drain-source current according to a gate-source voltage of a bias current generating transistor of the bias current generating part according to one embodiment of the present disclosure;

FIG. 6 is a graph showing the slew rate of the source signal output from each buffer of a typical output buffer part;

FIG. 7 is a graph showing the slew rate of the source signal output from each buffer of an output buffer part according to one embodiment of the present disclosure;

FIG. 8 is a graph showing the bias current input to each buffer by a bias current generating part according to one embodiment of the present disclosure when a source drive IC is located adjacent to one end of the display panel;

FIG. 9 is a graph showing the slew rate of the source signal output from each buffer of an output buffer part according to another embodiment of the present disclosure; and

FIG. 10 is a graph showing the bias current input to each buffer by a bias current generating part according to another embodiment of the present disclosure when a source drive IC is located in the center portion of the display panel.

### BEST MODE

Throughout the specification, the same reference numerals refer to substantially the same components. In the following description, detailed descriptions of configurations and features known in the art may be omitted if they are not relevant to the core configuration of the present disclosure. Terms used herein should be understood as follows.

The advantages and features of the present disclosure, and methods of achieving them will be apparent from the embodiments described in detail below in conjunction with the accompanying drawings. However, the present disclosure is not limited to the following embodiments, but may be implemented in various different forms; rather, the present embodiments are provided to make the description of the present disclosure complete and to allow those skilled in the art to fully understand the scope of the present disclosure, and the present disclosure is defined only within the scope of the appended claims.

The shapes, sizes, proportions, angles, numbers and the like shown in the accompanying drawings for the purpose of illustrating the embodiments of the present disclosure are merely examples, and the present disclosure is not limited thereto. Identical reference numerals may designate identical components throughout the description. Further, in describing the present disclosure, detailed descriptions of known related technologies may be omitted if it is considered to unnecessarily obscure the gist of the present disclosure.

The terms such as “comprising,” “including,” “having,” and “consisting of” used herein are generally intended to allow other components to be added unless the terms are used with the term “only.” References to components of a singular noun include the plural of that noun, unless specifically stated otherwise.

In interpreting components, they are construed to include a margin of error, even if it is not explicitly stated.

When describing a temporal contextual relationship is described, for example, such as “after,” “following,” “next to,” or “before,” it may also include non-contiguous cases unless “immediately” or “directly” is used.

The first, the second, and so on are used to describe various components, but these components are not limited by these terms. These terms are used only to distinguish one component from another. Therefore, the first component referred to herein may also be a second component within the technical idea of the present disclosure.

It should be understood that the term “at least one” includes any combination that can be presented from one or more relevant items. For example, the meaning of “at least one of the first, second, and third items” may mean each of the first, second, or third items, as well as any combination of items that may be presented from two or more of the first, second, and third items.

Each of the features of various embodiments of the present disclosure may be coupled or combined with one another in whole or in part, and may be technologically interlocked and operated in various ways, and each of the embodiments may be carried out independently or in conjunction with one another.

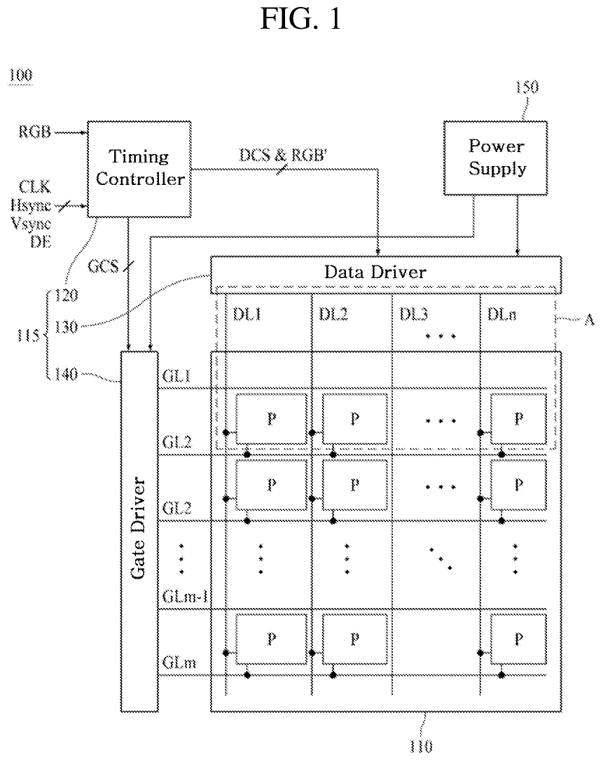

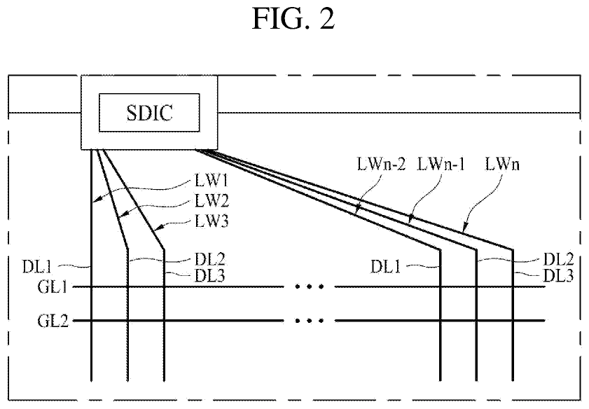

Hereinafter, with reference to FIGS. 1 and 2, a display device according to an embodiment of the present disclosure will be described in detail.

FIG. 1 is a diagram illustrating the configuration of a display device according to one embodiment of the present disclosure, and FIG. 2 is a plan view of a part A in FIG. 1.

FIG. 1 is a diagram illustrating a display device to which the display drive device according to one embodiment of the present disclosure is applicable. As shown in FIG. 1, a display device 100 includes a display panel 110 and a display drive device 115, wherein the display drive device 115 includes a timing controller 120, a data driver 130, and a gate driver 140.

The display panel 110 includes a plurality of gate lines GL1 to GLn and a plurality of data lines DL1 to Dlm, which intersect with each other to define a plurality of pixel areas, and pixels P provided in the plurality of pixel areas. The plurality of gate lines GL1 to GLn may be arranged horizontally and the plurality of data lines DL1 to DLm may be arranged vertically, but are not limited thereto.

The display panel 110 may be an organic light-emitting display panel in which an organic light-emitting diode (OLED) is formed in each pixel area.

Thin film transistors TFT transmit the data signals supplied through the data line DL1 to DLm to the pixels P in response to scan signals supplied through the gate lines GL1 to GLn.

The pixels P of the display panel 110 may be composed of red (R), green (G), blue (B), and white (W) sub-pixels. Each sub-pixel may be formed repeatedly in the row direction or may be formed in the form of a 2*2 matrix. In this case, color filters corresponding to respective colors are disposed in the red (R), green (G), and blue (B) sub-pixels, whereas no separate color filter is disposed in the white (W) sub-pixel. In one embodiment, the red (R), green (G), blue (B), and white (W) sub-pixels may be formed to have the same area ratio, but the red (R), green (G), blue (B), and white (W) sub-pixels may also be formed to have different area ratios.

The timing controller 120 receives various timing signals, including a vertical synchronization signal Vsync, a horizontal synchronization signal Hsync, a data enable (DE) signal, a clock signal CLK, and the like, from an external system (not shown) to generate a data control signal DCS to control the data driver 130 and a gate control signal GCS to control the gate driver 140. The timing controller 120 also receives image data RGB from an external system, converts it to image data RGB′ that may be processed by the data driver 130, and outputs it.

The data control signal DCS may include a source start pulse (SSP), a source sampling clock (SSC), and a source output enable (SOE) signal, and the gate control signal GCS may include a gate start pulse (GSP), a gate shift clock (GSC), and a gate output enable (GOE) signal.

Here, the source start pulse controls the timing of the start of data sampling of the n source drive ICs (not shown) that constitute the data driver 130. The source sampling clock is a clock signal that controls the sampling timing of data from each of the source drive ICs. The source output enable signal controls the output timing of each of the source drive ICs.

The timing controller 120 generates the gate control signal (GCS) that includes the gate start pulse (GSP), the gate shift clock (GSC), and the gate output enable (GOE) signal.

The gate start pulse controls the timing of the start of operation of the m gate drive ICs (not shown) that constitute the gate driver 140. The gate shift clock is a clock signal commonly input to one or more gate drive ICs, which controls the shift timing of a scan signals (gate pulse). The gate output enable signal designates the timing information for one or more gate drive ICs.

The timing controller 120 aligns the image data RGB received from the external system. Specifically, the timing controller 120 aligns the image data RGB′ to match the structure and characteristics of the display panel 110. The timing controller 120 transfers the aligned image data RGB′ to the data driver 130.

The gate driver 140 outputs gate signals synchronized with the source signals generated by the data driver 130 to the gate lines according to the timing signals generated by the timing controller 120. Specifically, the gate driver 140 outputs gate signals that are synchronized with the source signals to the gate lines based on the gate start pulse, the gate shift clock, and the gate output enable signal by the timing controller 120.

The gate driver 140 includes a gate shift register circuit, a gate level shifter circuit, and the like. Here, the gate shift register circuit may be formed directly on the TFT array substrate of the display panel by a gate in panel (GIP) process. The gate driver 140 supplies the gate start pulse and the gate shift clock signal to the gate shift register circuit formed using a GIP process on the TFT array substrate.

The gate driver 140 may be disposed in a non-display area where no pixels P are arranged by a gate driver in panel (GIP) process. For example, the gate driver 140 may be disposed in a non-display area on both outer sides of the display area in which the pixels P are arranged.

Alternatively, the gate driver 140 may include a plurality of gate drive integrated circuits, wherein the gate drive integrated circuits may be mounted on the gate flexible films. Each of the gate flexible films may be a tape carrier package or a chip on film. The gate flexible films may be attached to the non-display area (NDA) of the display panel 10 by tape automated bonding (TAB) using an anisotropic conductive film, thereby allowing the gate drive integrated circuits to be connected to the gate lines GL1 to GLm.

The data driver 130 converts the aligned image data RGB′ into a source signal according to the timing signal generated by the timing controller 120. Specifically, the data driver 130 converts the aligned image data RGB′ into the source signal according to the source start pulse, the source sampling clock, and the source output enable signal. The data driver 130 outputs the source signal corresponding to one horizontal line to the data lines for each horizontal period in which the gate signals are supplied to the gate lines. In this case, the data driver 130 may receive a gamma voltage from the gamma voltage generator (not shown) and convert the aligned image data RGB′ into the source signal using the gamma voltage. To this end, the data driver 130 may include at least one source drive integrated circuit (SDIC). The source drive integrated circuit (SDIC) supplies the analog image data signals DATA′ to the data lines DL1 to DLn.

The source drive integrated circuit (SDIC) of the data driver 130 may be connected to a bonding pad of the display panel 110 by tape automated bonding (TAB) or chip-on-glass (COG), may be disposed directly on the display panel 110, or may be integrated and disposed on the display panel 110. Additionally, each of the source drive integrated circuits (SDIC) of the data driver 130 may be implemented in a chip on film (COF) method. The chip-on-film with the source drive integrated circuit (SDIC) mounted thereon may be bonded to the source printed circuit board at one end and to the display panel 110 at the other end.

The source drive integrated circuit (SDIC) of the data driver 130 is connected to the data lines DL1 to DLn of the display panel 110. Specifically, the source drive integrated circuit (SDIC) is connected to the data lines DL1 to DLn via link wires LW1 to LWn of the display panel 110, as shown in FIG. 2, wherein the length of each of the link wires LW1 to LWn may vary according to the location of the source drive integrated circuit (SDIC) in the display panel 110. In particular, when the display panel 110 is large, the length differences between the source drive integrated circuit (SDIC) and the link wires LW1 to LWn for connecting the data lines DL1 to DLn of the display panel 110 may increase.

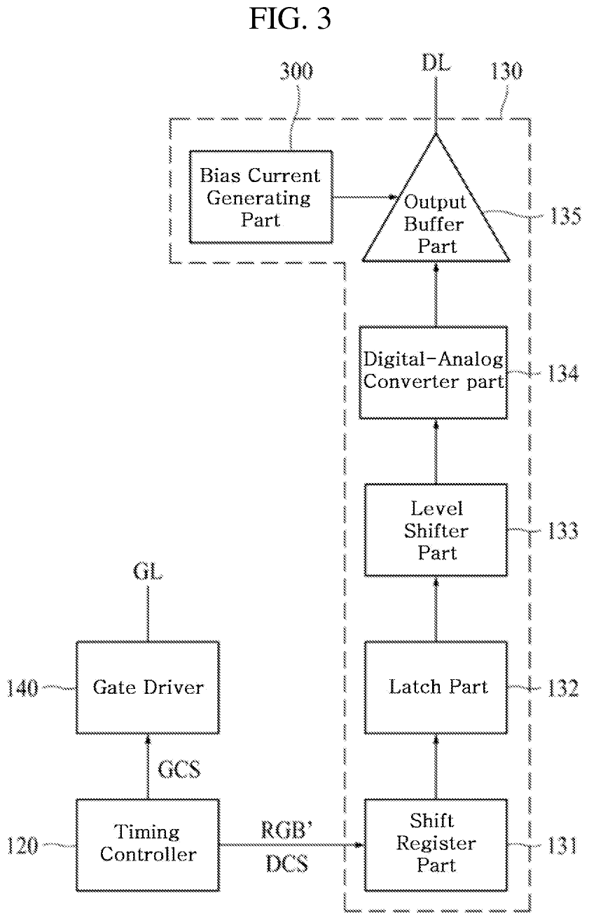

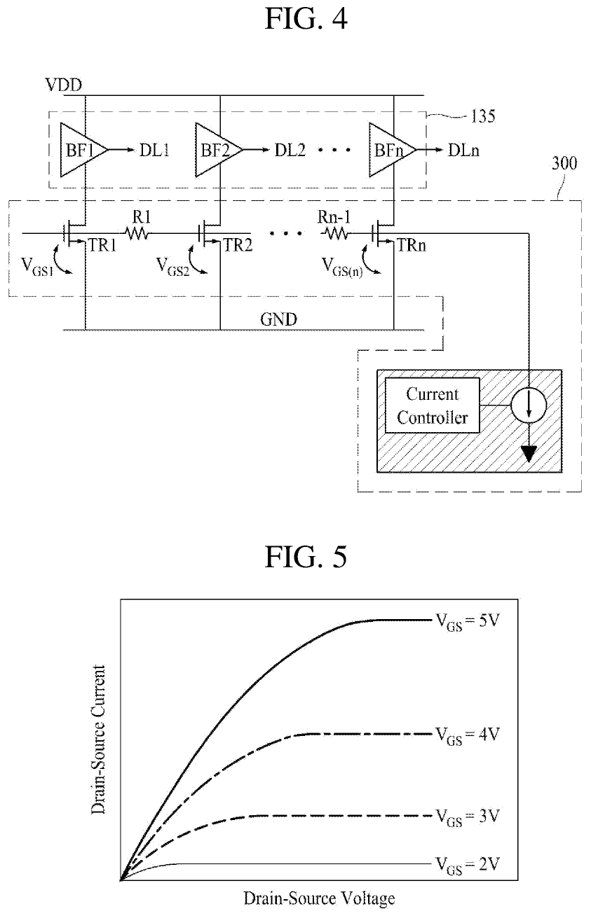

The display drive device 115 according to one embodiment of the present disclosure may compensate for resistance differences in the link wires LW1 to LWn due to length differences between the link wires LW1 to LWn of the display panel 110. This will be described in more detail with reference to FIGS. 3 and 4.

Although the data lines DL1 to DLn and the link wires LW1 to LWn connected to the data lines DL1 to DLn are shown in FIG. 2 as being connected to one source drive integrated circuit (SDIC), it is not limited thereto, and some data lines and some link wires may be connected to one source drive integrated circuit and some other data lines and some other link wires may be connected to another source drive integrated circuit. In other words, the data lines DL1 to DLn and the link wires LW1 to LWn may each be connected to a plurality of source drive integrated circuits.

A power supply 150 generates the various signals required by the gate driver 140 and the data driver 130. For example, the power supply 150 steps up or steps down the system voltage to generate analog power and digital power. In this case, the analog power may include a reference voltage, a common voltage, a gamma voltage, a gate high voltage, a gate low voltage, and the like, and the digital power may include a digital logic voltage, and the like. Additionally, the power supply 150 may supply current to, or may include, a current controller, which will be described later.

Hereinafter, with reference to FIGS. 3 to 8, the data driver according to one embodiment of the present disclosure will be described in detail.

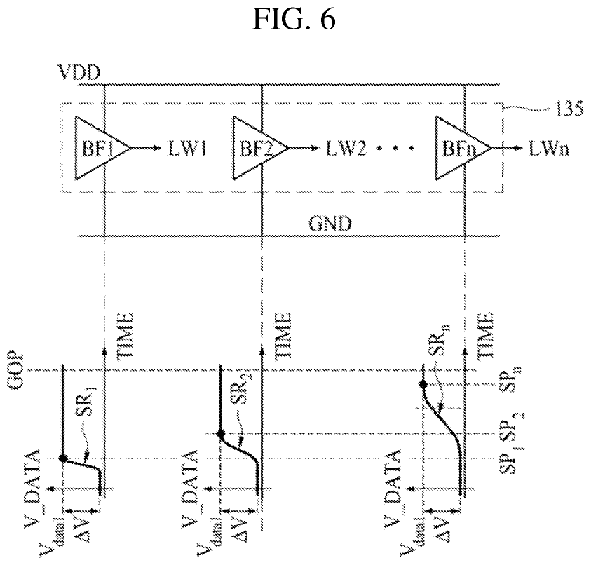

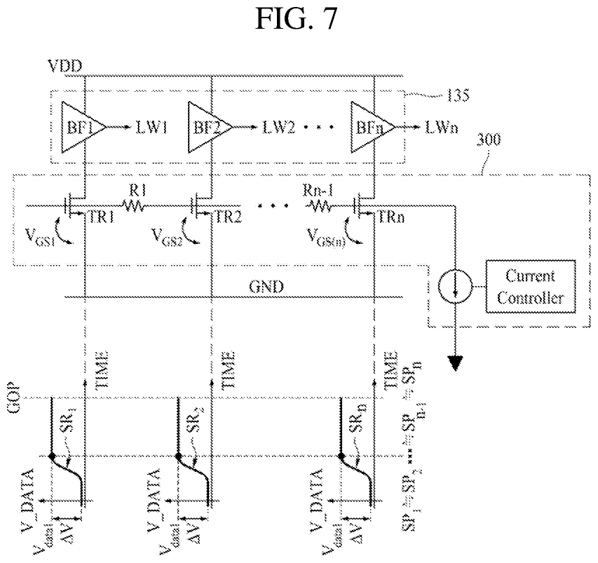

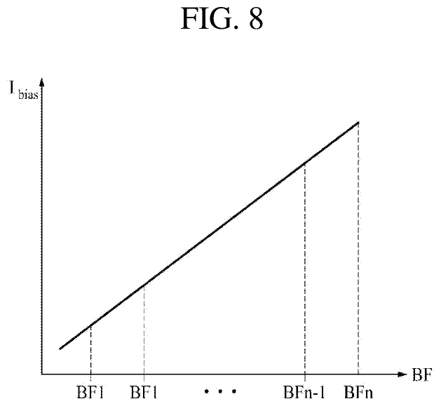

FIG. 3 is a block diagram schematically illustrating the configuration of a data driver according to one embodiment of the present disclosure. FIG. 4 is a circuit diagram illustrating an output buffer part and a bias current generating part according to one embodiment of the present disclosure. FIG. 5 is a graph of a drain-source current according to a gate-source voltage of a bias current generating transistor of the bias current generating part according to one embodiment of the present disclosure. FIG. 6 is a graph showing the slew rate of the source signal output from each buffer of a typical output buffer part. FIG. 7 is a graph showing the slew rate of the source signal output from each buffer of an output buffer part according to one embodiment of the present disclosure. FIG. 8 is a graph showing the bias current input to each buffer by the bias current generating part according to one embodiment of the present disclosure when a source drive IC is located adjacent to one side of the display panel.

The source drive integrated circuit (SDIC) of the data driver 130 converts the aligned image data RGB′ into the source signal according to the timing signal generated by the timing controller 120, as described above.

For this purpose, the source drive integrated circuit (SDIC) includes a shift register part 131, a latch part 132, a level shifter part 133, a digital-analog converter part 134, an output buffer part 135, and a bias current generating part 300, as shown in FIG. 3.

The shift register part 131 receives the source start pulse and the source sampling clock from the timing controller 120, and outputs a sampling signal by sequentially shifting the source start pulse according to the source sampling clock. The shift register part 131 transmits the sampling signal to the latch part 132.

The latch part 132 sequentially samples and latches the image data by the predetermined amount of units according to the sampling signal. The latch part 132 transmits the latched image data to the level shifter part 133.

The level shifter part 133 amplifies the level of the latched image data. Specifically, the level shifter part 133 amplifies the level of the image data to a level that the digital-analog converter part 134 may drive it. The level shifter part 133 transmits the level-amplified image data to the digital-analog converter part 134.

The digital-analog converter part 134 converts the image data to the source signal that is an analog signal. The digital-analog converter part 134 transmits the source signal converted to the analog signal to the output buffer part 135.

The output buffer part 135 receives the source signals from the digital-analog converter part 134 and outputs the same to a plurality of data lines DL1 to DLm. In this case, the output buffer part 135 may include a plurality of buffers BF1 to BFn corresponding to the plurality of data lines DL1 to DLm.

The bias current generating part 300 is connected to the plurality of buffers BF1 to BFn to supply a bias current I_{bias}. In particular, according to one embodiment of the present disclosure, the bias current generating part 300 supplies a bias current I_{bias} corresponding to the length of the link wires LW1 to LWn of the display panel 110 that are connected to their corresponding buffers. For this purpose, the bias current generating part 300 may include a plurality of bias current transistors TR1 to TRn connected to a plurality of buffers BF1 to BFn, a plurality of bias resistors R1 to Rn-1, and a current controller, as shown in FIG. 4.

The plurality of bias current transistors TR1 to TRn are connected to the plurality of buffers BF1 to BFn as described above, and are also connected to a ground voltage GND, and the current controller. Specifically, each of the plurality of bias current transistors TR1 to TRn is connected to the current controller via its gate electrode to receive a gate current from the current controller, connected to the ground voltage GND via its source electrode, and connected to a corresponding buffer via its drain electrode, so that the source-drain current of each bias current transistor is supplied to the corresponding buffer as the bias current I_{bias}. In other words, the source-drain currents of the plurality of bias current transistors TR1 to TRn supplied as the bias currents I_{bias} to the buffers BF1 to BFn are determined according to the gate currents of the bias current transistors TR1 to TRn supplied by the current controller.

The bias currents Ibias supplied to the buffers are determined according to the gate currents supplied to the gate electrodes of the bias current transistors by the current controller. Specifically, as shown in FIG. 4, the larger the gate-source voltage V_{GS} of a bias current transistor, the higher the drain-source current, and thus the higher the bias current I_{bias} input to a buffer connected to that bias current transistor.

The plurality of bias resistors R1 to Rn-1 are each located between the plurality of bias current transistors TR1 to TRn. The plurality of bias resistors R1 to Rn-1 may serve to regulate the gate-source voltages due to the gate currents input to the gate electrodes of the plurality of bias current transistors TR1 to TRn.

In addition, the current controller supplies currents to the gate electrodes of the plurality of bias current transistors TR1 to TRn. In particular, according to one embodiment of the present disclosure, differences in the resistance of the link wires between the plurality of display panels may be efficiently compensated by means of the current controller. In other words, by controlling the currents supplied by the current controller to the gate electrodes of the plurality of bias current transistors TR1 to TRn, the difference in the resistance of the link wires between the plurality of display panels may be efficiently compensated, whereby the display drive device according to one embodiment of the present disclosure may shorten the calibration time to the plurality of display panels during the manufacturing process.

While the current controller is shown in the drawing as being included in the bias current generating part 300, it is not limited thereto, and the current controller may be included in the power supply 150 described above, or may be a separate component of the display drive 115.

As described above, as the display panel 110 becomes larger, the length difference between the panel link wires LW1 to LWn connecting the source drive integrated circuit (SDIC) and the data lines DL1 to DLm of the display panel 110 increases, and the wire resistance difference increases according to the length difference of these panel link wires LW1 to LWn. Accordingly, as the panel link wires LW1 to LWn become longer, the slew rates SR₁ to SRₙ, which are the rate of voltage change with respect to time (AV/SP) of the source signal V_DATA output through the panel link wires LW1 to LWn, increases. In other words, the shorter the length of the panel link wires, the shorter the delay caused by the resistance of the panel link wires, and the larger the slew rates SR₁ to SRₙ of the source signals V_DATA output through the panel link wires. On the other hand, the longer the length of the panel link wires, the longer the delay caused by the resistance of the panel link wires LW1 to LWn may be, and the smaller the slew rates SR₁ to SRₙ of the output source signals V_DATA may be. For example, when the source drive integrated circuit (SDIC) is located adjacent to the first data line DL1, as shown in FIG. 5, the first buffer BF1 connected to the first panel link wire LW1 having the shortest length outputs the source signal V_DATA at the largest slew rate (SR₁=ΔV/SP₁), and the (n)^{th} buffer BFn, which is connected to the (n)^{th} panel link line LWn having the longest length, outputs the source signal V_DATA at the smallest slew rate (SRₙ=ΔV/SPₙ).

To compensate for differences in the slew rates due to differences in the lengths of the panel link wires LW1 to LWn connected to the data lines DL1 to DLn of such display panels, the display drive device 115 according to one embodiment of the present disclosure may reduce the slew rates SR of the source signals V_DATA output through the panel link wires LW1 to LWn in proportion to the lengths of these panel link wires LW1 to LWn connecting the data lines and the source drive integrated circuit (SDIC).

Specifically, the gate-source voltages V_{GS}, which are proportional to the lengths of the panel link wires connected to the bias current transistors, may be supplied to the plurality of bias current transistors TR1 to TRn by means of the plurality of bias resistors R1 to Rn-1 located between the plurality of bias current transistors TR1 to TRn and the current controller that supplies gate currents to the plurality of bias current transistors TR1 to TRn. For example, if the source drive integrated circuit (SDIC) is located adjacent to the first data line DL1, the smallest value of the gate-source voltage V_{GS} is supplied to the first bias current transistor TR 1 that is connected to the first panel link wire LW1 having the shortest length and the first buffer BF1, and the largest value of the gate-source voltage V_{GS} is supplied to the (n)^{th} bias current transistor TRn that is connected to the (n)^{th} panel link wire LWn having the longest length and the (n)^{th} buffer BFn.

As described above, since the source-drain currents of the bias current transistors TR1 to TRn increase as the gate-source voltages V_{GS} of the bias current transistors TR1 to TRn increase, the source-drain currents of the bias current transistors TR1 to TRn may increase in proportion to the lengths of the panel link wires connected to the bias current transistors. In this way, the source-drain currents of the bias current transistors TR1 to TRn are input to the buffers BF1 to BFn as the bias currents I_{bias} of the buffers BF1 to BFn connected to the bias current transistors TR1 to TRn.

The bias current I_{bias} of each buffer may increase in proportion to the length of the panel link wire connected to that buffer, and the slew rate SR of the source signal V_DATA output from that buffer may decrease in inverse proportion to the length of the panel link wire connected to that buffer. For example, as shown in FIGS. 7 and 8, when the source drive integrated circuit (SDIC) is located adjacent to the first data line DL1, the first buffer BF1 connected to the first panel link wire LW1 having the shortest length may receive the smallest bias current I_{bias} as an input, which results in the largest reduction in the slew rate SR₁ of the first buffer BF1, and the (n)^{th} buffer BFn connected to the (n)^{th} panel link wire LWn having the longest length may receive the largest bias current I_{bias} as an input, which results in the smallest reduction in the slew rate SR_{N} of the (n)^{th} buffer BFn. Accordingly, as shown in FIG. 7, the slew rates SR₁ to SRₙ of the source signals V_DATA output from the buffers BF1 to BFn to the data lines DL1 to DLn via the panel link wires LW1 to LWn may be compensated by the bias current generating part 300 according to one embodiment of the present disclosure, so that they become substantially the same.

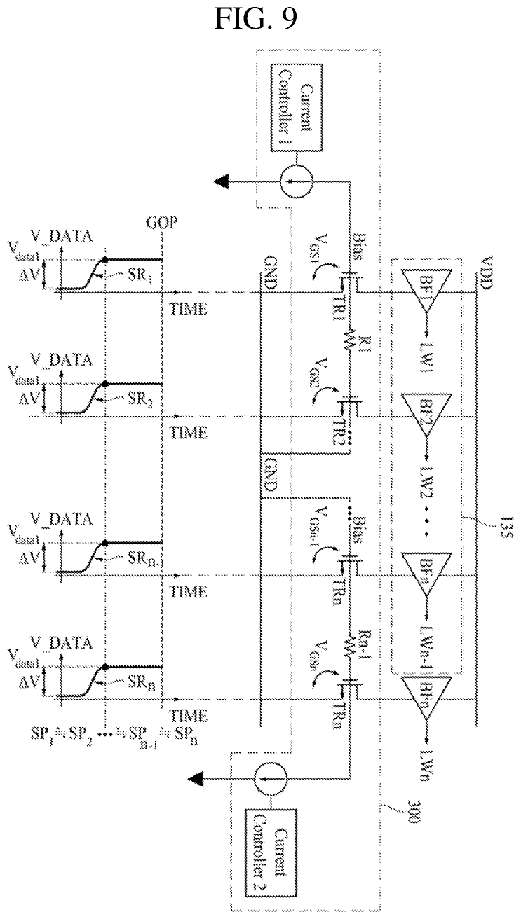

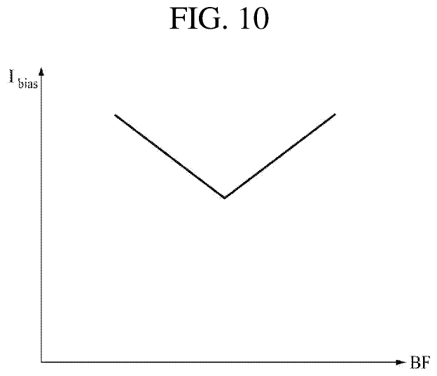

Hereinafter, with reference to FIGS. 9 and 10, a display drive device according to another embodiment of the present disclosure will be described in detail.

FIG. 9 is a graph showing the slew rate of the source signal output from each buffer of an output buffer part according to another embodiment of the present disclosure, and FIG. 10 is a graph showing the bias current input to each buffer by a bias current generating part according to another embodiment of the present disclosure when a source drive IC is located in the center of the display panel.

Referring to FIG. 9, according to another embodiment of the present disclosure, the bias current generating part 300 includes a plurality of bias current transistors TR1 to TRn connected to a plurality of buffers BF1 to BFn, a plurality of bias resistors R1 to Rn-1, a first current controller 1, and a second current controller 2.

According to another embodiment of the present disclosure, the gate-source voltages V_{GS}, which are proportional to the lengths of the panel link wires connected to the bias current transistors TR1 to TRn, may be supplied to the bias current transistors TR1 to TRn by means of the plurality of bias resistors R1 to Rn-1 located between the plurality of bias current transistors TR1 to TRn and the current controller that supplies gate currents to the plurality of bias current transistors TR1 to TRn. For example, when the source drive integrated circuit (SDIC) is located adjacent to the center portion of the display panel 110, the largest value of the gate-source voltage V_{GS} is supplied to the first bias current transistor TR1 that is connected to the first panel link wire LW1 having the longest length and the first buffer BF1, and is supplied to the (n)^{th} bias current transistor TRn that is connected to the (n)^{th} panel link wire LWn having the longest length like the first panel link wire LW1 and the (n)^{th} buffer BFn.

To this end, according to another embodiment of the present disclosure, some of the plurality of bias current transistors TR1 to TRn connected to the corresponding ones of the plurality of buffers BF1 to BFn may be connected to the first current controller 1 and others may be connected to the second current controller 2. For example, the first to (k)^{th} buffers (where k is an integer less than n) may be connected to the first current controller 1, and the (k+1)^{th} to (n)^{th} buffers may be connected to the second current controller 2. Here, if the source drive integrated circuit (SDIC) is located at the center of the display panel, k may be an integer closest to n/2.

Because the bias current I_{bias} of each buffer increases in proportion to the length of the panel link wire connected to that buffer, the slew rate SR of the source signal V_DATA output from that buffer may decrease in inverse proportion to the length of the panel link wire connected to that buffer. For example, when the source drive integrated circuit (SDIC) is located adjacent to the center portion of the display panel 110, as shown in FIGS. 9 and 10, the first buffer BF1 connected to the first panel link wire LW1 having the longest length and the (n)^{th} buffer BFn connected to the (n)^{th} panel link wire LWn receive the largest bias current I_{bias} as an input, resulting in the smallest reduction in the slew rate SR_{N} of the first buffer BF1 and the (n)^{th} buffer BFn, while the buffer connected to the panel link wire having the shortest length may receive the smallest bias current I_{bias} as an input, resulting in largest reduction of the slew rate. In other words, as shown in FIG. 9, the slew rates SR₁ to SRₙ of the source signals V_DATA output from the buffers BF1 to BFn to the data lines DL1 to DLn via the panel link wire LW1 to LWn may be compensated by the bias current generating part 300 according to one embodiment of the present disclosure, so that they become substantially the same.

It should be understood that the embodiments described above are illustrative in all aspects and do not limit the present disclosure. The scope of the present disclosure is represented by the following claims rather than the above detailed description, and it should be construed that all changes or modifications derived from the meaning and scope of the claims and their equivalent concepts are included within the scope of the present disclosure.

It will be apparent to those skilled in the art that the present disclosure may be embodied in other specific forms without departing from the features of the present disclosure. Therefore, the above detailed description should not be construed as limiting in any respect and should be considered exemplary. The scope of the present disclosure should be determined by a reasonable interpretation of the appended claims, and all changes within the equivalent scope of the present disclosure are included in the scope of the present disclosure.

### INDUSTRIAL APPLICABILITY

Embodiments of the present disclosure as described above may be applied to a variety of display devices.

1. A display drive device comprising:
first and second buffers that are electrically connected to first and second panel link wires of a display panel, respectively;
a first bias current transistor configured to supply a first bias current to the first buffer, and a second bias current transistor configured to supply a second bias current to the second buffer; and
a first current controller configured to supply a gate current to each of the first and second bias current transistors,
wherein the magnitude of the first bias current and the second bias current is determined based on a length of each of the first panel link wire and the second panel link wire.

2. The display drive device of claim 1, wherein when the first panel link wire has a shorter length than the second panel link wire, the first bias current has a smaller value than the second bias current.

3. The display drive device of claim 1, wherein when the first panel link wire has a shorter length than the second panel link wire, a gate current input to the first bias current transistor has a smaller value than a gate current input to the second bias current transistor.

4. The display drive device of claim 1, wherein the first bias transistor is:
connected to the current controller via its gate electrode to receive the gate current input as an input,
connected to a ground voltage GND via its source electrode, and
connected to the first buffer via its drain electrode.

5. The display drive device of claim 1, wherein the source-drain current of the first bias current transistor is input to the first buffer as the first bias current.

6. The display drive device of claim 1, further comprising:
at least one bias resistor located between the first bias current transistor and the second bias current transistor.

7. The display drive device of claim 1, further comprising:
third and fourth buffers electrically connected to third and fourth panel link wires of the display panel, respectively;
third and fourth bias current transistors configured to supply bias currents to the third and fourth buffers, respectively; and
a second current controller configured to supply a gate current to each of the third and fourth bias current transistors,
wherein the third and fourth bias current transistors supply the bias currents to the third and fourth buffers connected to the third and fourth panel link wires in proportion to the lengths of the third and fourth panel link wires, respectively.

8. A display device comprising:
first and second data lines connected to pixels and configured to supply source signals;
a data drive device configured to output the source signals to the first and second data lines; and
first and second panel link wires configured to electrically connect the first and second data lines and the data drive device,
wherein the data drive device includes:
first and second buffers that are electrically connected to the first and second panel link wires, respectively;
a first bias current transistor configured to supply a first bias current to the first buffer, and a second bias current transistor configured to supply a second bias current to the second buffer; and
a first current controller configured to supply a gate current to each of the first and second bias current transistors, and
wherein the magnitude of the first bias current and the second bias current is determined based on each length of the first panel link wire and the second panel link wire.

9. The display device of claim 8, wherein when the first panel link wire has a shorter length than the second panel link wire, the first bias current has a smaller value than the second bias current.

10. The display device of claim 8, wherein when the first panel link wire has a shorter length than the second panel link wire, a gate current input to the first bias current transistor has a smaller value than a gate current input to the second bias current transistor connected to the second buffer.

11. The display device of claim 8, wherein the slew rate of a source signal output from the first buffer to the first data line via the first panel link wire and the slew rate of a source signal output from the second buffer to the second data line via the second panel link wire are substantially the same.

12. The display device of claim 8, wherein the first bias transistor is:
connected to the current controller via its gate electrode to receive the gate current input as an input,
connected to a ground voltage GND via its source electrode, and
connected to the first buffer via its drain electrode.

13. The display device of claim 8, wherein the source-drain current of the first bias current transistor is input to the first buffer as the first bias current.

14. The display device of claim 8, further comprising:
at least one bias resistor located between the first bias current transistor and the second bias current transistor.
